(19) United States
(12) Patent Application Publication
(10) Pub. No.: US 2008/0029556 A1
(43) Pub. Date: Feb. 7, 2008

(54) Liquid soap leakage-proof structure for soap dispensing apparatus

(76) Inventor: Jan-Sun Chen, Taipei City (TW)

Correspondence Address: BIRCH STEWART KOLASCH & BIRCH, PO BOX 747, FALLS CHURCH, VA, 22040-0747, US

(21) Appl. No.: 11/498,191

(22) Filed: Aug. 3, 2006

(51) Int. Cl. B65D 47/10; B67D 5/06; B65D 37/00

(52) U.S. Cl. 222/541.6; 222/207; 222/181.3

(57) ABSTRACT

A liquid soap leakage-proof structure for soap dispensing apparatus comprising a pointed end portion which is integrally extended from the bottom end of a liquid soap discharge opening of the liquid soap dispensing apparatus to prevent liquid soap from leaking during storing or transportation. The pointed end portion has an upper end connecting to the liquid soap discharge opening on which a weaker portion is formed so that the pointed end portion can be broken as desired to expose the discharge opening to discharge the liquid soap.

### BACKGROUND OF THE INVENTION

1. Field of the Invention

The present invention relates to a liquid soap leakage-proof structure for a soap dispensing apparatus that has a closed and breakable pointed end portion integrally formed on a liquid soap outlet to prevent liquid soap from flowing out caused by inadvertent squeezing while the liquid soap container is in a storing condition before being used.

2. Description of the Prior Art

A conventional soap dispensing apparatus 2 as shown in FIGS. 1 and 2 generally includes a connector 20 coupling with a liquid soap container 1 by screwing. The bottom of the connector has a duct 21 inserting in the top end of a sleeve 22. The sleeve 22 has a pump housing 24 on one side formed by an elastic pressure bulb 23. The sleeve 22 further houses an axial strut 25 which is coupled with a upper valve 26 and a lower valve 27 that form a valve chamber 28 between them. The sleeve 22 has a tubular wall 29 between the valve chamber 28 and the pump housing 24 that has a hole 31 formed thereon between the upper and lower valves 26 and 27. The sleeve 22 has a liquid soap discharge opening 32 on the bottom.

In practice, the soap dispensing apparatus 2 usually is held in an electric-sensing soap squeezing device 4 to automatically squeeze a selected amount of liquid soap as shown in FIG. 2. When in use, the pump housing 24 receives pressure from an external force. The pressure opens the outlet and closes the inlet of the valve chamber 28 through the hole 31 so that liquid soap 10 can be squeezed out through the discharge opening 32. By contrast, when the pressure is absent in the pump housing 24, the pressure bulb 23 returns to its original shape due to elasticity to generate a vacuum suction force, and the outlet of the valve chamber 28 closes and the inlet opens so that the liquid soap 10 in the connector 20 flows into the valve chamber 28. Thus during the next operation cycle the liquid soap can be output when the valve chamber 28 is opened.

The liquid soap dispensing apparatus 2 set forth above is coupled with the liquid soap container 1. Before the apparatus is installed on the soap squeezing device 4, the liquid soap container 1 usually is located on a lower side while the soap dispensing apparatus 2 is directed upwards to store the liquid soap. The liquid soap does not flow out through the discharge opening 32 because a balance is reached between the gravity force and inner and external pressure of the container. But during transportation the liquid soap container 1 or elastic pressure bulb 23 could be squeezed inadvertently and result in flowing out of the liquid soap through the sleeve 22 and discharge opening 32. This not only creates loss of the liquid soap, also smears the liquid soap container.

### SUMMARY OF THE INVENTION

The primary object of the present invention is to provide a liquid soap leakage-proof structure for a soap dispensing apparatus to overcome the problem of the conventional soap dispensing apparatus caused by inadvertent squeezing of the liquid soap container or elastic pressure bulb and result in leaking loss of liquid soap.

To achieve the foregoing object, the soap dispensing apparatus of the invention is largely constructed like the conventional one, including a connector coupling with a liquid soap container by screwing. The bottom of the connector is coupled with a sleeve. The sleeve has a pump housing on one side formed by an elastic pressure bulb. The sleeve further axially houses an upper valve and a lower valve that form a valve chamber between them. The sleeve has a tubular wall between the valve chamber and the pump housing that has a hole formed thereon. The leakage-proof structure according to the invention further includes a pointed end portion integrally extended from the bottom end of a liquid soap discharge opening of the sleeve. The pointed end portion has a closed bottom end. Hence during storing or transportation, if the liquid soap container or the elastic pressure bulb is squeezed by an external force, liquid soap is stopped by the closed pointed end portion without flowing out. In addition, the connecting portion of the pointed end portion and the liquid soap discharging opening has a weaker structural portion, such as a smaller thickness. When in use, the weaker structural portion can be broken easily by an external force to separate the pointed end portion from the sleeve so that the discharge opening is exposed for discharging the liquid soap.

The liquid soap leakage-proof structure thus constructed can prevent the liquid soap from flowing out during the soap dispensing apparatus is in a storing condition. Moreover, the leakage-proof structure has a breakable separation structure to allow the liquid soap to be squeezed out when desired. Thus it eliminates the disadvantages occurred to the conventional techniques.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a sectional view of a conventional soap dispensing apparatus.

FIG. 2 is a perspective view of the conventional soap dispensing apparatus shown in FIG. 1 installed on a soap squeezing device.

FIG. 3 is a sectional view of an embodiment of the soap dispensing apparatus of the invention.

FIG. 4 is a fragmentary sectional view of an embodiment of the liquid soap leakage-proof structure of the invention.

FIG. 5 is a perspective view of an embodiment of the soap dispensing apparatus shown in FIG. 4 coupling with a liquid soap container to be installed on a soap squeezing device.

FIG. 6 is a schematic view of an embodiment of the liquid soap leakage-proof structure of the invention with the pointed end portion being broken and separated from the bottom of the soap dispensing apparatus.

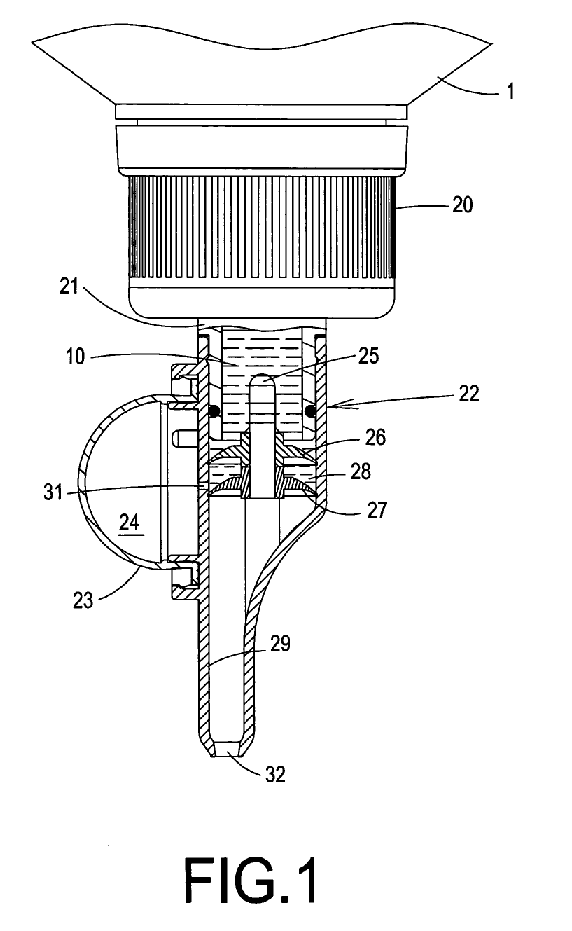

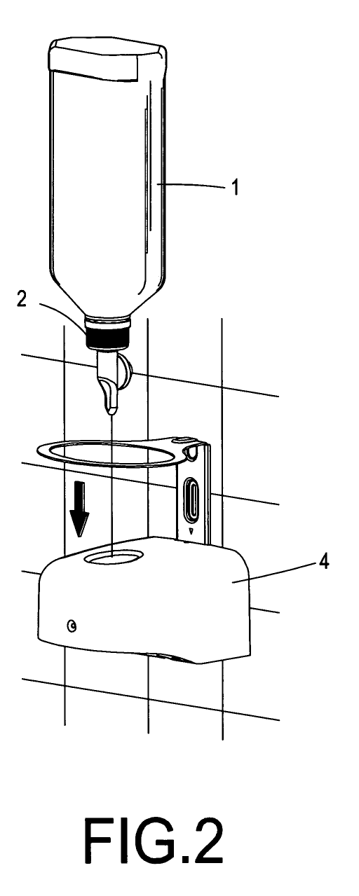

### DESCRIPTION OF THE PREFERRED EMBODIMENTS

The present invention is a liquid soap leakage-proof structure for a soap dispensing apparatus. The soap dispensing apparatus is substantially constructed like the conventional soap dispensing apparatus 2 previously discussed. It includes a connector 20 coupling with a liquid soap container 1 by screwing. The connector 20 has a duct 21 on the bottom inserting into a top end of a sleeve 22. The sleeve 21 has a pump housing 24 on one side formed by an elastic pressure bulb 23. The sleeve 22 further axially houses a upper valve 26 and a lower valve 27 that form a valve chamber 28 between them. The sleeve 22 has a tubular wall 29 between the valve chamber 28 and the pump housing 24 that has a hole 31 formed thereon.

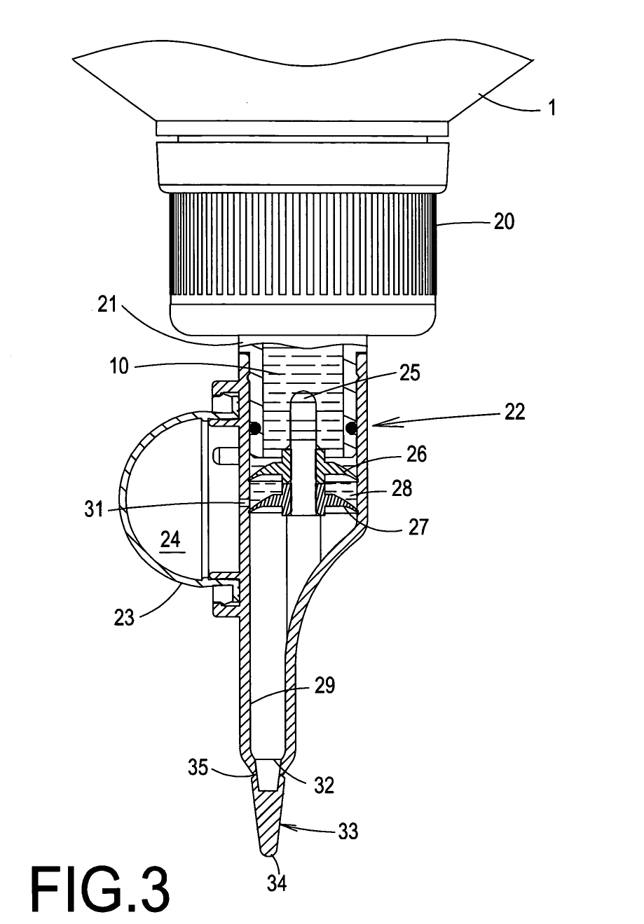

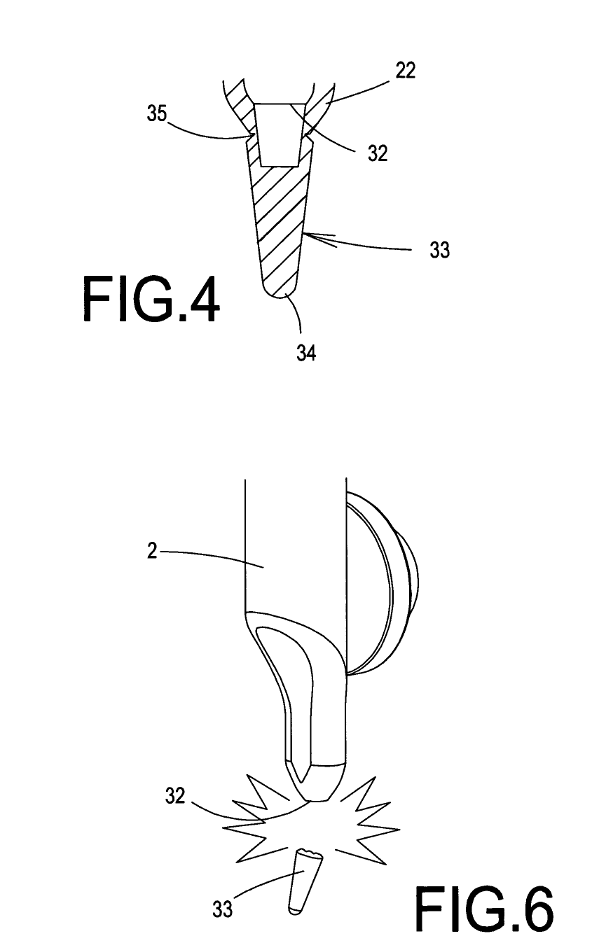

The liquid soap leakage-proof structure according to the invention further includes a pointed end portion 33 integrally extended from the bottom end of a liquid soap discharge opening 32 of the sleeve 22. The pointed end portion 33 has a closed bottom end 34. The pointed end portion 33 has an upper end connecting to the liquid soap discharge opening 32. An annular severing groove 35 is formed on the connecting portion such that the thickness at the annular severing groove 35 is smaller than that of the sleeve 22 and other portions of the pointed end portion 33. As a result, the pointed end portion 33 at the annular severing groove 25 forms a weaker structure relative to other portions of the soap dispensing apparatus (referring to FIGS. 3 and 4).

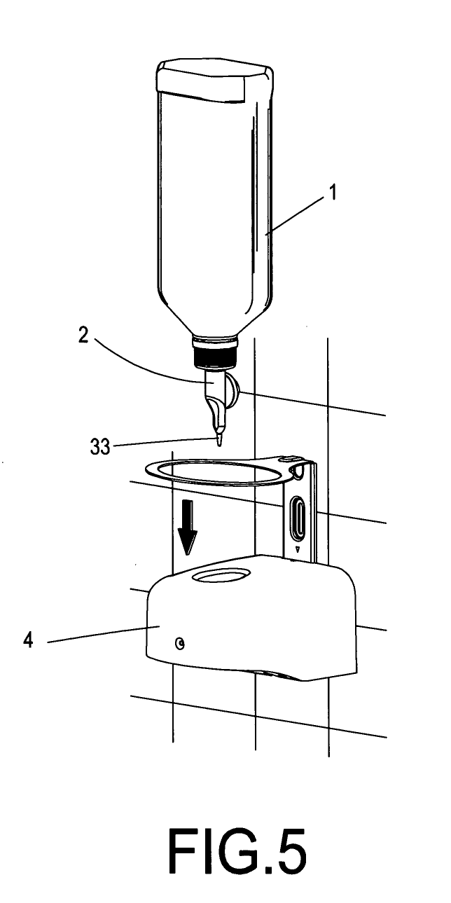

With the pointed end portion 33 formed on the soap dispensing apparatus as previously discussed, the liquid soap discharge opening 32 at the bottom of the sleeve 22 is sealed by the pointed end portion 33 before the soap dispensing apparatus is installed on a soap squeezing device. Hence liquid soap cannot be squeezed out either when the liquid soap container 1 or the elastic pressure bulb 23 is squeezed by an external force. Moreover, the pointed end portion 33 has an easy breaking structure due to the annular severing groove 35 is formed on the connecting portion with the sleeve 22. After the liquid soap container 1 and the soap dispensing apparatus 2 are installed on the soap squeezing device 4, the pointed end portion 33 can be broken and separated at the annular severing groove 35 as shown in FIGS. 5 and 6. And the discharge opening 32 can be exposed to discharge the liquid soap.

While the aforesaid embodiment employs the annular severing groove 35 to form a thinner thickness to facilitate breaking and separation of the pointed end portion 33 and the sleeve 22, other embodiments may also be adopted to achieve the same function, such as using a brittle material.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

I claim:

1. A liquid soap leakage-proof structure for a soap dispensing apparatus comprising:
a pointed end portion which is integrally extended from a bottom end of a liquid soap discharge opening of the soap dispensing apparatus, the pointed end portion having a closed bottom end to prevent liquid soap from flowing out; the pointed end portion being breakable by an external force to separate from the soap dispensing apparatus to expose the liquid soap discharge opening of the soap dispensing apparatus.

2. The liquid soap leakage-proof structure for a soap dispensing apparatus of claim 1, wherein the pointed end portion has an upper end connecting to the liquid soap discharge opening on which an annular severing groove is formed.

3. The liquid soap leakage-proof structure for a soap dispensing apparatus of claim 2, wherein the annular severing groove is formed has a smaller thickness than the rest portion of the pointed end portion.
